(19) United States
(12) Patent Application Publication
(10) Pub. No.: US 2019/0308723 A1
(43) Pub. Date: Oct. 10, 2019

(54) FLYING VEHICLE THRUST DEVICE

(71) Applicant: Hoversurf, Inc., Burlingame, CA (US)

(72) Inventor: Aleksandr ATAMANOV, St. Petersburg (RU)

(73) Assignee: Hoversurf, Inc., Burlingame, CA (US)

(21) Appl. No.: 15/945,667

(22) Filed: Apr. 4, 2018

(51) Int. Cl. B64C 29/00; B64D 27/24

(52) U.S. Cl. CPC B64C 29/0058; B64D 27/24; B64C 29/0066

(57) ABSTRACT

A flying vehicle including powering a plurality of vertical thrustors, said vertical thrustors coupled to an airframe and positioned to provide thrust in substantially one direction. Also, powering a plurality of horizontal thrustors, said horizontal thrustors disposed to provide thrust in a direction substantially orthogonal to the thrust of the vertical thrustors, and adjusting the angle of attack from a wing, said wing adjustable in both a horizontal and vertical direction. The vertical or horizontal thrustors include electrically driven rotor which includes a series of blades mounted around the rotor. The rotor and blades are positioned inside an input nozzle with a tapered inlet. The blades are positioned near the narrowest portion of the input nozzle. Multiple layers of blades may be employed to achieve a desired thrust including stacked blades with varying blade pitch.

### BACKGROUND

The invention relates to the field of aviation, namely, to flying vehicles (FV) for vertical (or near vertical) take-off and landing often referred to a hybrid vertical take-off and landing (VTOL) aircraft. These combine multicopter features with fixed wing features. Multicopters are classified as rotorcraft, as opposed to fixed-wing aircraft, because their lift is generated by a set of vertically oriented propellers (rotors) instead of fixed wing craft which generate lift using airflow across a wing.

Recent advances in electronics allowed for the production of affordable, lightweight flight controllers, accelerometers (IMU), global positioning system and cameras. This resulted in the multicopter configuration becoming popular for small unmanned aerial vehicles. Accordingly, multicopters are cheaper and more durable than conventional helicopters owing to their mechanical simplicity. Their smaller blades are also advantageous because they possess less kinetic energy, reducing their ability to cause damage and making the vehicles safer for close interaction. However, as size increases, fixed propeller multicopters develop disadvantages over conventional helicopters because increasing blade size increases their momentum. This means that changes in blade speed take longer to effectuate, which negatively impacts control. Conventional helicopters do not experience this problem as increasing the size of the rotor disk does not significantly impact the ability to control blade pitch.

Coupled with the aforementioned multicopter operation may be a fixed wing aircraft. To operate conventional fixed wing aircraft, lift is generated by airflow over the wings. This requires motion of the aircraft in a certain direction, so motors are required to provide force in a horizontal direction. Accordingly, high efficiency, variable speed motors designs are likely to be in demand for multicopter operations

### SUMMARY

Disclosed herein are systems and method for a flying vehicle said systems and methods including powering a plurality of vertical thrustors, said vertical thrustors coupled to an airframe and positioned to provide thrust in substantially one direction. Also, powering a plurality of horizontal thrustors, said horizontal thrustors disposed to provide thrust in a direction substantially orthogonal to the thrust of the vertical thrustors, and adjusting the angle of attack from a wing, said wing adjustable in both a horizontal and vertical direction. In operation, the position of the wing and the thrust from the vertical thrustors and horizontal thrustors operate together to provide for light of the flying vehicle.

The vertical or horizontal thrustors include electrically driven rotor which includes a series of blades mounted around the rotor. The rotor and blades are positioned inside an input nozzle with a tapered inlet. The blades are positioned near the narrowest portion of the input nozzle. Multiple layers of blades may be employed to achieve a desired thrust—for example, and without limitation, stacked blades with varying blade pitch may be collectively driven by the electric motor.

An exit nozzle is configured to direct the output air flow from the blades to an exhaust. The exit nozzle, together with the input nozzle operate collectively as as a tube that is pinched in the middle, making a carefully balanced, asymmetric hourglass shape. The pinched tube, by altering the volume of the airflow through the nozzle, also operates to alter the pressure of the airflow through the nozzle.

Various sensors may be employed, together with different power sources to effectuate emergency flying procedures in the event a malfunction in a rotor, motor or motor controller. Setpoints for the sensors may be preprogrammed to effectuate detection of failure events. The operational procedures may be selected depending on the sensor input and put into operation in a manner to counter-act the anticipated results of the failure condition.

The construction and method of operation of the invention, however, together with additional objectives and advantages thereof will be best understood from the following description of specific embodiments when read in connection with the accompanying drawings and claims.

### BRIEF DESCRIPTION OF THE DRAWINGS

FIG. 1 shows a functional block diagram of a first embodiment of certain aspects of a flying vehicle according to the current disclosure.

FIG. 2 illustrates an embodiment of a thrust source (thrustor) that may be employed according to the current disclosure.

FIG. 3 shows a view of a flying vehicle according to certain embodiments of the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### Detailed Description

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system, or sensors, and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor(s) contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may include communications devices such as a wireless transceiver. These wireless devices may include a processor, memory coupled to the processor, displays, keypads, WiFi, Bluetooth, GPS and other I/O functionality. Alternatively, the entire processing system may be self-contained on a single device in certain embodiments.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, as well as remote connected computer systems.

### System Components

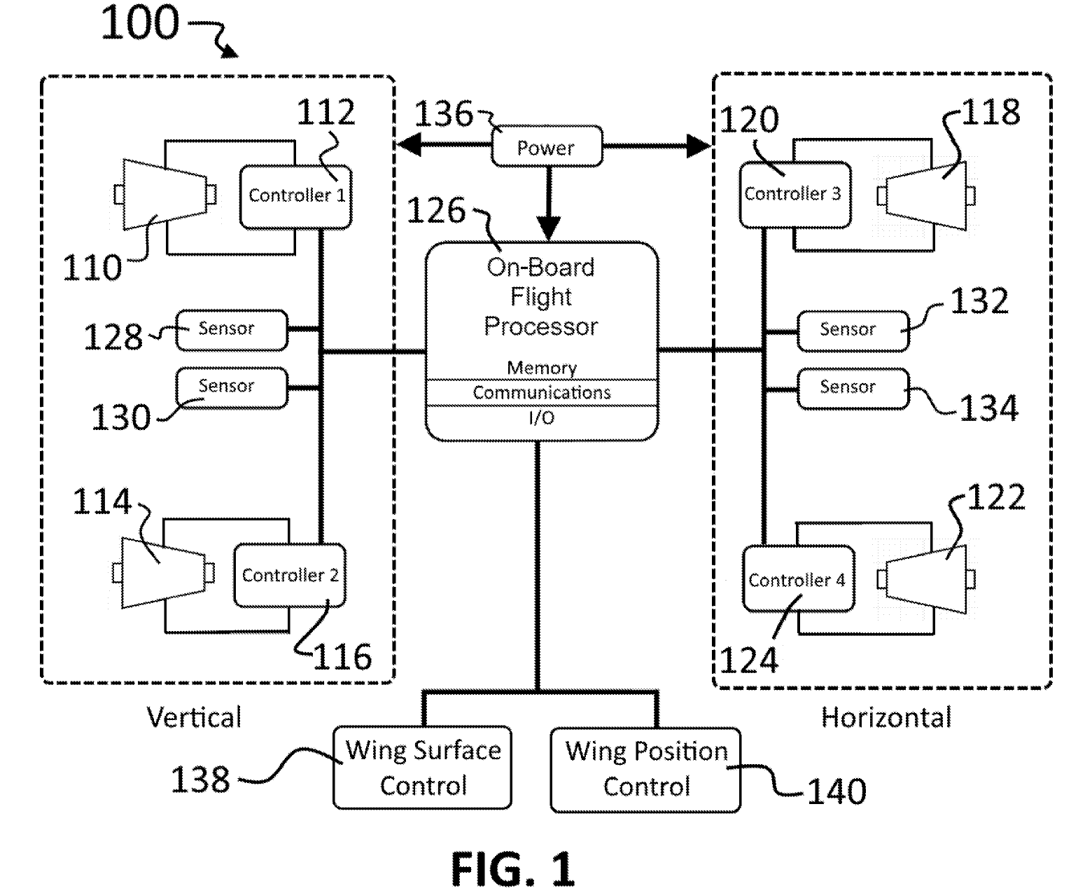

FIG. 1 shows a functional block diagram of a first embodiment of certain aspects of a flying vehicle according to the current disclosure. In FIG. 1 a flying vehicle represented as having two sets of turbines 110, 114, 118, and 124, each attached to a motor controller 112, 116, 118, and 124 as shown. One set of turbines (112 and 116) are disposed in the flying vehicle to provide vertical thrust, while the other set 118 and 122 are disposed to provide horizontal thrust. While only two turbines are depicted in each set, the inventors contemplate using different numbers and arrangements of turbines. For example, and without limitation, the vertical set may include 8 turbines while the horizontal set includes only two turbines. The number and size of the turbines will be determined by the payload requirements of the flying vehicle.

The turbines are attached to controllers 12, 116, 118, and 122 for providing variable power to the turbines under the control of an on-board flight processors 126. To effectuate power usage multiple power sources, such as batteries, 136 or solar convertors (not shown) may be employed. These power sources may operate independently powering different operations, operate in tandem, or provide power under the control of the on-board flight processor 126.

The on-board flight processor 126 is coupled to memory, input-output (I/O) devices, and communications systems such as wireless radio, Bluetooth, GPS receiver, and the like. The wireless communications may include a link for controlling the flying vehicle from a remote operator or, in some embodiments the pre-planned flight may be stored in memory and used by the processor 126 to control flight.

Sensors 128, 130, 132, and 134 are coupled to the on-board flight processor 126. Depending on the nature of these sensors they may also be coupled to one or more of the controllers, the motors power supply, or other electro-mechanical assembly. The types and operation of the sensors may be pre-selected for specific flight characteristics. For example, and without limitation, sensors employed may include:
Vibration sensors for detecting motor vibration
Level sensors for detecting pitch, yaw and roll
Current sensors for detecting current of a motor or motor controller
Back-electromotive force (EMF) sensors for sensing motor operation
Tachometers for sensing speed of motor rotation
Power sensors for sensing power supplied to a motor or controller
Barometers for sensing change in altitude
Gyroscopes for sensing spin
Accelerometers for sending flying vehicle motion

To accurately sense meaningful information, the sensors must operate with a high degree of sensitivity, however, the sensitivity of the sensors, the type of sensors, and the quantity of sensors may all be selected on a flight-by-flight basis, thus allowing for a user to set equipment for a desired result. Moreover, each sensor may require information to predetermine whether the sensed parameter is operating within an acceptable range. For example, and without limitation, since vibration is to be expected during flight, the sensor may be pre-adjusted to only indicate when the vibration exceeds a certain setpoint.

Navigation may be further effectuated using accelerometers and gyroscopes such as those conventionally available by ST Micro, Inc. These devices include 3-axis gyroscopes with sensing structure for motion measurement along all three orthogonal axes—other solutions on the market rely on two or three independent structures.

Conventionally available gyroscopes may be employed to measure angular velocity with a wide range to meet the requirements of different applications, ranging from dead reckoning to more precise navigation. ST's angular rate sensors are already used in mobile phones, tablets, 3D pointers, game consoles, digital cameras and many other devices.

Commercially available motion processing units may also be used to effectuate certain embodiments as disclosed here. For example, and without limitation, the MPU6000 family of devices by TDK, inc. which includes a 3-axis gyroscope and a 3-axis accelerometer on the same silicon die together with an onboard digital motion processor capable of processing complex 9-axis sensor fusion algorithms.

Sensors may provide for direct programming of a setpoint. In which case the sensor outputs a signal indicating the status. For example, it may only send a signal when the setpoint is reached. Other sensors may provide continual readings of condition, say vibration frequency. In those cases, a setpoint may be stored in memory for access by program control software.

Further coupled to the power source and on-board flight processor 126 are wing surface controls 138 and wing position controls 140. The wing surface controls control operation of the wings, including, but not limited to, ailerons, flaps, spoilers, and other control surfaced used to operate the vehicle in flight. Since these surfaces are under control of the processor 126, they may be operated to perform a preprogrammed flight or in response to signals received through the communications subsystem. Conventional flight operations may be performed in conjunction with the vertical thrust subsystem 138 and the wing position control subsystem 140.

Also coupled to the processor 126 is a wing position control 140 which provides for a dynamic wing that has a moveable profile. The wings are hinged and coupled to an actuator that shifts the wings during operation. This effectuates a change in the angle of attack of the entire wing and may increase the lift or other operations. Moreover, a folding dynamic wing, when positioned to minimized drag, may save energy and allow for flight over large distances after a vertical take-off. Conventionally known as a variable-sweep wing, (or “swing wing”), the airplane wing, or set of wings, may be swept back and then returned to its original position during flight. The variable-sweep wing is most useful for those aircraft that are expected to function at both low and high speed, such as VTOLs.

Some embodiments may employ flight control technology and structural materials to tailor the aerodynamics and structure of aircraft, which may remove the need for variable sweep angle to achieve the required performance; instead, wings are given computer-controlled flaps on both leading and trailing edges that increase or decrease the camber or chord of the wing automatically to adjust to the flight regime.

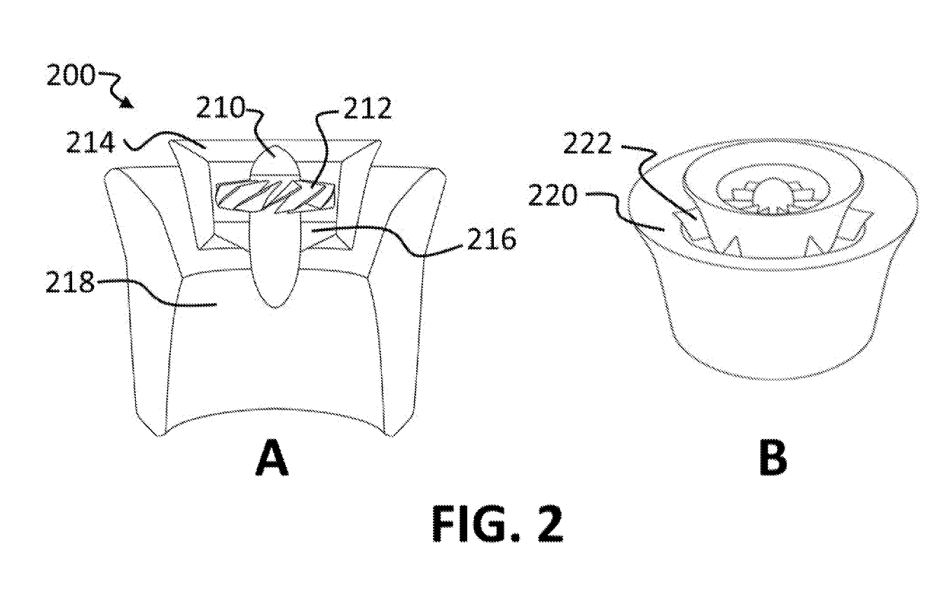

FIG. 2 illustrates an embodiment of a thrust source (thrustor) 200 that may be employed according to the current disclosure. In FIG. 2 an electrically driven rotor 210 includes a series of blades 212 mounted around the rotor 210. The rotor 210 and blades 212 are positioned inside an input nozzle 214. The input nozzle 214 has a tapered inlet and the blades 212 are positioned near the narrowest portion of the input nozzle 214. While a single layer of blades 212 are shown, multiple layers of blades 212 may be employed to achieve a desired thrust. For example, and without limitation, stacked blades 212 with varying blade pitch may be collectively driven by the electric motor.

An exit nozzle 218 is configured to direct the output air flow from the blades 210 to exhaust. The exit nozzle 218, together with the input nozzle 214 operate collectively as a form of ‘de Laval” nozzle which is generally characterized as a tube that is pinched in the middle, making a carefully balanced, asymmetric hourglass shape. The pinched tube, by altering the volume of the airflow through the nozzle, also operates to alter the pressure of the airflow through the nozzle.

FIG. 2 view B, shows an embodiment of the thrust source 200 with additional blades 222 mounted on the rotor and the additional blades 222 positioned in a second input nozzle 220. Collectively both sets of blades force air through the exit nozzle 218. In operation, the number of blades, the velocity of the rotor and the shape of the nozzles operate to provide a degree of thrust. Accordingly, different embodiments of the current disclosure may employ variations of the thrustors described herein.

The embodiment of FIG. 2 may be effectuated with an input nozzle 214, having a taper with a larger input orifice, and a narrower input orifice, a variable-speed, electrically driven motor 216, said motor coupled to a central rotor 210 with blades 212 positioned on the central rotor 212, each blade disposed to at an angle, wherein the rotor 210 and blades 212 are disposed in the narrower end of the input nozzle. An outlet nozzle 218 having a larger output orifice and a narrower output orifice abutting the narrower input orifice and enclosing the blades 212. Gas flow, such as air, is driven by the blades 212 through the input nozzle to the output nozzle. Certain embodiments may include a second set of blades or variable pitch blades.

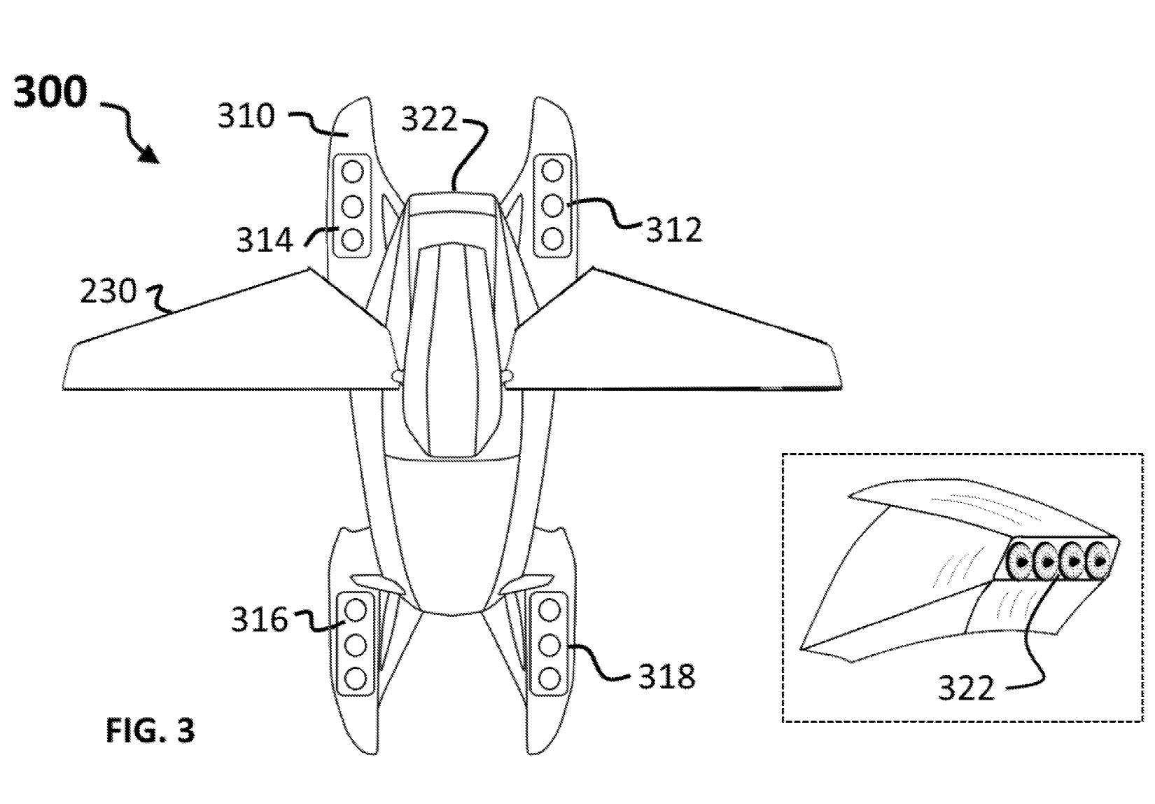

FIG. 3 shows a view of a flying vehicle according to certain embodiments of the current disclosure. In FIG. 3 an airframe 310 includes four vertical thrust assemblies 312, 314, 316 and 318. Each vertical thrust assembly 312, 314, 316, and 318 includes three thrustors disposed to provide thrust in the same direction. While three thrustors are shown for each thrust assembly, this disclosure should be read to include different amounts of thrustors. Embodiments may be effectuated using different numbers of the thrustors to provide for different amounts of list, fuel efficiency and weight requirements. In addition, safety concerns may help select the number of thrustors because in the event of a thrustor failure, the remaining thrustors may operate to provide safe flight.

The thrust assemblies and the individual thrustors may be operated under control of a user or programmatically through instructions provided by a processor. In some embodiments, each thrust assembly 312, 314, 316, and 318 operates as a single unit using a single control signal to the assembly. Flight control, in some embodiments, may operate similar to a quadcopter because the thrust assemblies are positioned in the four corners of the airframe 310. Different numbers of thrust assemblies may be used in some embodiments depending on the desired lift and control.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Horizontal Drives

Included on the airframe 310 is a thrust assembly 322 positioned orthogonally to the thrust of the vertical thrust assemblies to provide horizontal thrust. The horizontal thrust assembly 322, shown from a rear perspective in the insert, allows for providing horizontal thrust. Horizontal thrust generated when the wing 320 is angled to provide lift during flight will allow operation as a “fixed wing” aircraft, reducing or eliminating reliance on vertical thrustors. Since fixed wing aircraft are more fuel efficient than rotating propellers, transitioning from vertical to horizontal thrusters may save energy and increase flying time for a given amount of fuel and power.

Certain embodiments as shown and described herein employ both vertical and horizontal thrusters as well as an adjustable wing. In operation, the three elements may operate together to effectuated a flight operation. For example, and without limitation, flight may begin using only vertical thrusters. Once at a certain altitude, say clear of trees or other obstacles, the horizontal thrustors may provide horizontal thrust as the wing is being positioned to provide lift at that velocity. When the horizontal velocity is sufficient, the vertical thrustors taper back and the weight of the flying vehicle will be supported at altitude by the wings, substantially using only horizontal thrust.

For landing, a similar operation may be employed in reverse wherein the vertical thrustors are engaged to provide lift as the wing is positioned to accommodate a restricted landing area. As the burden of light shifts to the vertical thrustors, then the horizontal thrustors will provide less thrust to allow for landing the flying vehicle.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A thrust device including:
A tapered input nozzle, said input nozzle having a larger input orifice, and a narrower input orifice;
a variable-speed, electrically driven motor, said motor coupled to a central rotor;
a plurality of blades, said blades disposed on the central rotor, each blade disposed at an angle, wherein the rotor and blades are disposed in the narrower input orifice, and
an outlet nozzle, said outlet nozzle having a larger output orifice and a narrower output orifice, said narrower outlet orifice abutting the narrower input orifice,
where gas flow is driven by the plurality of blades through the input nozzle to the output nozzle.

2. The device of claim 1 wherein the narrower input orifice and narrower output orifice and substantially equal diameter.

3. The device of claim 1 further including
a plurality of second blades, said second blades coupled to the rotor and disposed inside a second inlet nozzle, wherein gas flow is driven by the second blades into the outlet nozzle.

4. A method including:
disposing an electrically-driven motor on an airframe, said motor coupled to a central rotor, said central rotor including a plurality of angled blades disposed about a central axis;
disposing a tapered input nozzle about the blades, wherein at least a portion of the narrow end of the tapered input nozzle is disposed about the blades;
disposing a tapered exit nozzle about the blades wherein at least a portion of the narrow end of the tapered exit nozzle is disposed about the blades, and
operating the electrically-driven motor to force gas flow through the input nozzle to the output nozzle to create thrust.

5. The method of claim 4 further including:
a plurality of second angled blades, said second blades coupled to the rotor at a second angle, said blades operable to force gas through the outlet nozzle.

6. A flying vehicle including:
a plurality of vertical thrustors, said vertical thrustors including an electrically-driven fan disposed substantially near the narrow point of a pinched tube nozzle;
a plurality of horizontal thrustors, said horizontal thrustors said vertical thrustors including an electrically-driven fan disposed substantially near the narrow point of a pinched tube nozzle, and further disposed substantially orthogonal to the vertical thrustors, and
an airframe,
wherein the vertical thrustors operate to provide flight to the airframe.

7. The vehicle of claim 6 wherein the vertical thrustors are grouped into a single assembly, operating from a common control signal.
